(19) United States
(12) Patent Application Publication
(10) Pub. No.: US 2026/0149546 A1
(43) Pub. Date: May 28, 2026

(54) METHOD AND APPARATUS FOR DETERMINING TRANSMISSION CONFIGURATION INDICATOR (TCI) STATE

(71) Applicant: BEIJING XIAOMI MOBILE SOFTWARE CO., LTD., Beijing (CN)

(72) Inventors: Liangang CHI, Beijing (CN); Gaoming DUAN, Beijing (CN)

(73) Assignee: BEIJING XIAOMI MOBILE SOFTWARE CO., LTD., Beijing (CN)

(21) Appl. No.: 19/123,437

(22) PCT Filed: Oct. 24, 2022
(86) PCT No.: PCT/CN2022/127070

§ 371 Date: Apr. 23, 2025

(51) Int. Cl. H04L 5/00

(52) U.S. Cl. CPC H04L 5/0053

(57) ABSTRACT

Disclosed in embodiments of the present disclosure are a method and an apparatus for determining a transmission configuration indicator (TCI) state, applicable to the technical field of communications. The method, performed by a terminal device, includes: determining a value of a first information field in indication information sent by a network device, where the indication information is used for indicating a TCI state; according to the value of the first information field, determining a manner in which the indication information indicates the TCI state; and according to the manner in which the indication information indicates the TCI state, determining an identifier of the TCI state indicated by the indication information.

### CROSS-REFERENCE TO RELATED APPLICATIONS

The present application is a U.S. National Stage of International Application No. PCT/CN2022/127070, filed on Oct. 24, 2022, the content of which is incorporated by reference herein in its entirety for all purposes.

### TECHNICAL FIELD

The present disclosure relates to the field of communication technology, and in particular to a method and device for determining a transmission configuration indication (TCI) state.

### BACKGROUND

Distributed multi-input multi-output (MIMO) is developed on the basis of traditional classical MIMO technology, which expands the application scope of traditional MIMO. For terminal devices, distributed MIMO technology means that there will be multiple base stations serving them at the same time, and there is no cell switching. Without the concept of cell boundaries, the user experience will be smoother. When multiple transmission reception points (TRPs) serve a terminal device, since different TRPs are in different positions in space, it is necessary to indicate the corresponding beam information for different TRPs through different transmission configuration indicator (TCI) states.

### SUMMARY

The embodiments of the present disclosure provide a method and device for determining a transmission configuration indication (TCI) state.

According to a first aspect of the embodiments of the present disclosure, there is provided a method for determining a transmission configuration indication TCI state, performed by a terminal device, including:
determining a value of a first information field in indication information sent by a network device, where the indication information is configured to indicate a TCI state;
determining a way in which the indication information indicates the TCI state according to the value of the first information field; and
determining an identifier of the TCI state indicated by the indication information according to the way in which the indication information indicates the TCI state.

The terminal device first determines the value of the first information field in the received indication information, and then determines the way in which the indication information indicates the TCI state according to the value of the first information field, and then determines the identifier of the TCI state indicated in the indication information according to the determined way. Thus, the terminal device can determine the TCI state groups containing different numbers of TCI states through the indication information of different indication ways, thereby providing conditions for the terminal device to access more TRPs at the same time, and meeting the requirements of joint transmission in a multi-TRP system.

According to a second aspect of the embodiments of the present disclosure, there is provided a method for determining a transmission configuration indication TCI state, performed by a network device, including: determining a way for indicating a TCI state to a terminal device;
determining a value of a first information field in indication information according to the way for indicating the TCI state, where the indication information is configured to indicate the TCI state; and
sending the indication information to the terminal device.

According to a third aspect of the embodiments of the present disclosure, there is provided a communication device, including:
a processing module, configured to determine a value of a first information field in indication information sent by a network device, where the indication information is configured to indicate the TCI state;
where the processing module is further configured to determine a way in which the indication information indicates the TCI state according to the value of the first information field; and
the processing module is further configured to determine an identifier of the TCI state indicated by the indication information according to the way in which the indication information indicates the TCI state.

According to a fourth aspect of the embodiments of the present disclosure, there is provided a communication device, including:
a processing module, configured to determine a way for indicating a TCI state to a terminal device;
the processing module is further configured to determine a value of a first information field in the indication information according to the way for indicating the TCI state, where the indication information is configured to indicate the TCI state; and
a transceiver module, configured to send the indication information to the terminal device.

According to a fifth aspect of the embodiments of the present disclosure, there is provided a communication system, including a processor. When the processor calls a computer program in a memory, the method according to the above first aspect is performed.

According to a sixth aspect of the embodiments of the present disclosure, there is provided a communication system, including a processor. When the processor calls a computer program in a memory, the method according to the above second aspect is performed.

According to a seventh aspect of the embodiments of the present disclosure, there is provided a communication system, including a processor and a memory. The memory stores a computer program. The processor runs the computer program stored in a memory, to cause the communication device to perform the method according to the above first aspect.

According to an eighth aspect of the embodiments of the present disclosure, there is provided a communication system, including a processor and a memory. The memory stores a computer program. The processor runs the computer program stored in a memory, to cause the communication device to perform the method according to the above second aspect.

According to a ninth aspect of the embodiments of the present disclosure, there is provided a communication system, including a processor and an interface circuit. The interface circuit is configured to receive code instructions and transmit the code instructions to the processor. The processor is configured to run the code instructions to cause the communication device to perform the method according to the above first aspect.

According to a tenth aspect of the embodiments of the present disclosure, there is provided a communication system, including a processor and an interface circuit. The interface circuit is configured to receive code instructions and transmit the code instructions to the processor. The processor is configured to run the code instructions to cause the communication device to perform the method according to the above second aspect.

According to an eleventh aspect of the embodiments of the present disclosure, there is provided a communication system, including the communication device according to the third aspect and the communication device according to the fourth aspect; or including the communication device according to the fifth aspect and the communication device according to the sixth aspect; or including the communication device according to the seventh aspect and the communication device according to the eighth aspect; or including the communication device according to the ninth aspect and the communication device according to the tenth aspect.

According to a twelfth aspect of the embodiments of the present disclosure, there is provided a computer-readable storage medium, for storing instructions used by the above terminal device, when the instructions are executed, the terminal device is configured to perform the method according to the above first aspect.

According to a thirteenth aspect of the embodiments of the present disclosure, there is provided a computer-readable storage medium, for storing instructions used by the above terminal device, when the instructions are executed, the terminal device is configured to perform the method according to the above second aspect.

According to a fourteenth aspect of the embodiments of the present disclosure, there is provided a computer program product. When the computer program product is executed on the computer, the computer is configured to perform the method according to the above first aspect.

According to a fifteenth aspect of the embodiments of the present disclosure, there is provided a computer program product. When the computer program product is executed on the computer, the computer is configured to perform the method according to the above second aspect.

According to a sixteenth aspect of the embodiments of the present disclosure, there is provided a chip system, including at least one processor and an interface, for supporting a terminal device to implement functions involved in the first aspect, such as determining or processing at least one of data and information involved in the above method. In one possible design, the chip system further includes a memory. The memory is configured to store necessary computer programs and data of the terminal device. The chip system can be composed of chips, or can include chips and other discrete devices.

According to a seventeenth aspect of the embodiments of the present disclosure, there is provided a chip system, including at least one processor and an interface, for supporting a terminal device to implement functions involved in the second aspect, such as determining or processing at least one of data and information involved in the above method. In one possible design, the chip system further includes a memory. The memory is configured to store necessary computer programs and data of the terminal device. The chip system can be composed of chips, or can include chips and other discrete devices.

According to an eighteenth aspect of the embodiments of the present disclosure, there is provided a computer program. When the computer program is executed on the computer, the computer is configured to perform the method according to the above first aspect.

According to a nineteenth aspect of the embodiments of the present disclosure, there is provided a computer program. When the computer program is executed on the computer, the computer is configured to perform the method according to the above second aspect.

### BRIEF DESCRIPTION OF THE DRAWINGS

In order to more clearly illustrate the technical solutions in the embodiments of the present disclosure or the background technology, the drawings required for use in the embodiments of the present disclosure or the background technology will be described below.

FIG. 1 is a schematic diagram of an architecture of a communication system provided by an embodiment of the present disclosure;

FIG. 2 is a flow diagram of a method for determining a transmission configuration indication TCI state provided by an embodiment of the present disclosure;

FIG. 3A to FIG. 3C are structural schematic diagrams of indication information provided by an embodiment of the present disclosure;

FIG. 4 is a flow diagram of another method for determining a transmission configuration indication TCI state provided by an embodiment of the present disclosure;

FIG. 5 is a flow diagram of another method for determining a transmission configuration indication TCI state provided by an embodiment of the present disclosure;

FIG. 6 is a flow diagram of still another method for determining a transmission configuration indication TCI state provided by an embodiment of the present disclosure;

FIG. 7 is a structural schematic diagram of a communication device provided by an embodiment of the present disclosure;

FIG. 8 is a structural schematic diagram of another communication device provided by an embodiment of the present disclosure;

FIG. 9 is a structural schematic diagram of a chip provided by an embodiment of the present disclosure.

### DETAILED DESCRIPTION

For ease of understanding, the terms involved in the present disclosure are first introduced.

### 1. Downlink Control Information (DCI)

Downlink control information sent by a network device to a terminal device, carried by the physical downlink control channel (PDCCH), includes uplink and downlink resource allocation, hybrid automatic repeat request (HARQ) information, power control, etc.

### 2. Transmission Configuration Indication (TCI)

Transmission Configuration Indication (TCI) is configured to inform the terminal device to receive the physical downlink control channel (PDCCH) and the physical downlink shared channel (PDSCH) using the same receiving space parameters/information as those used for receiving a specific synchronization signal block (SSB) or channel state information reference signal (CSI-RS) sent by the network device; or to inform the terminal device to send the physical uplink control channel (PUCCH) and the physical uplink shared channel (PUSCH) using the same sending space parameters/information as those used for sending a specific reference signal (such as SRS or CSI-RS).

### 3. Medium Access Control Control Element (MAC CE)

MAC CE is a way to exchange control information between UE and network in addition to radio resource control (RRC) messages and non-access stratum (NAS) messages, and is configured to exchange MAC layer control information.

Generally, the network device can configure up to 128 TCI states for the terminal device through RRC signaling, and then indicate (activate/deactivate) some TCI state groups through MAC CE, and the indicated TCI state groups can be used only through the TCI information field indication in DCI.

With the application of vehicle-mounted terminals, terminal devices are becoming more and more powerful and can support simultaneous access to more TRPs, such as more than 4 TRPs. Therefore, in a multi-TRP (M-TRP) transmission system based on single downlink control information (DCI), how to activate as many TCI states as possible is an urgent problem to be solved.

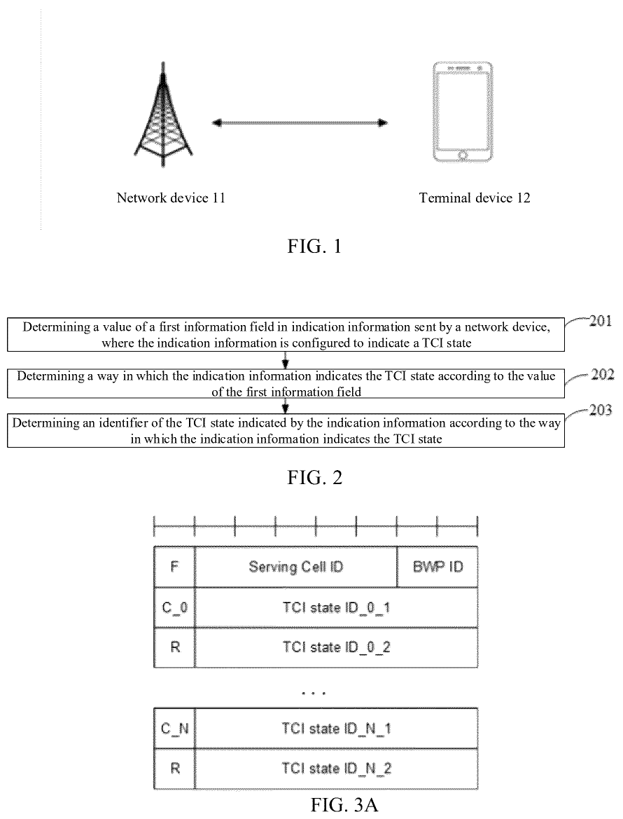

Please refer to FIG. 1, which is a schematic diagram of an architecture of a communication system provided by an embodiment of the present disclosure. The communication system may include but is not limited to a network device and a terminal device. The number and form of devices shown in FIG. 1 are only used for example and do not constitute a limitation on the embodiment of the present disclosure. In actual applications, two or more network devices and two or more terminal devices may be included. The communication system shown in FIG. 1 takes a network device 11 and a terminal device 12 as an example.

It should be noted that the technical solution of the embodiment of the present disclosure can be applied to various communication systems. For example: long term evolution (LTE) system, fifth generation (5G) mobile communication system, 5G new radio (NR) system, or other future new mobile communication systems.

The network device 11 in the embodiment of the present disclosure is an entity configured to transmit or receive signals on the network side. For example, evolved NodeB (eNB), transmission reception point (TRP), next generation NodeB (gNB) in NR system, base stations in other future mobile communication systems or access nodes in wireless fidelity (WiFi) system, etc. The embodiments of the present disclosure do not limit the specific technology and specific device form adopted by the network device. The network device provided in the embodiments of the present disclosure may be composed of a central unit (CU) and a distributed unit (DU), where the CU may also be referred to as a control unit. The CU-DU structure may be used to split the protocol layers of the network device, such as the base station. The functions of some protocol layers are placed in the CU for centralized control, and the functions of the remaining part or all of the protocol layers are distributed in the DU. The DU is centrally controlled by the CU.

The terminal device 12 in the embodiments of the present disclosure is an entity on the user side for receiving or transmitting signals, such as a mobile phone. The terminal device may also be referred to as a terminal, a user equipment (UE), a mobile station (MS), a mobile terminal (MT), etc. The terminal device may be a car with communication function, a smart car, a mobile phone, a wearable device, a tablet computer (Pad), a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit the specific technology and specific device form adopted by the terminal device.

It can be understood that the communication system described in the embodiments of the present disclosure is to more clearly illustrate the technical solution of the embodiments of the present disclosure, and does not constitute a limitation on the technical solution provided by the embodiments of the present disclosure. It can be known to those skilled in the art that with the evolution of the system architecture and the emergence of new service scenarios, the technical solution provided by the embodiments of the present disclosure is also applicable to similar technical problems.

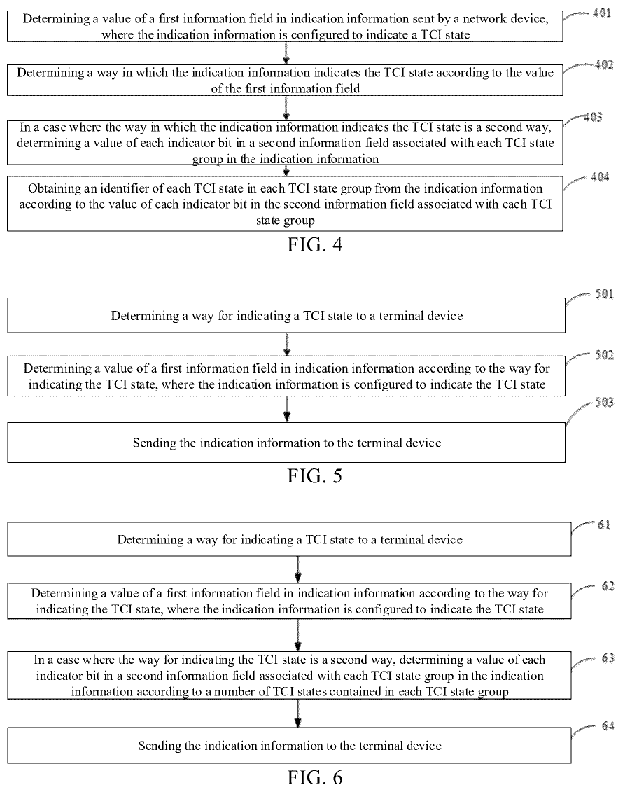

In this system, the terminal device 12 can implement the method shown in any embodiment of FIG. 2 or FIG. 4 of the present disclosure. The network device 11 can implement the method shown in FIG. 5 or FIG. 6 of the present disclosure.

It can be understood that the communication system described in the embodiment of the present disclosure is to more clearly illustrate the technical solution of the embodiment of the present disclosure, and does not constitute a limitation on the technical solution provided by the embodiment of the present disclosure. It is known to those skilled in the art that with the evolution of the system architecture and the emergence of new service scenarios, the technical solution provided by the embodiment of the present disclosure is also applicable to similar technical problems.

In the present disclosure, mainly aiming at the problem of how to activate as many TCI states as possible for a terminal device that can access multiple TRPs at the same time in an M-TRP transmission system based on single DCI, a new method for determining the TCI state is proposed. Different TCI state indication ways are adopted according to the number of TCI states to be indicated. Then, when the terminal device receives the indication information, the terminal device firstly determines the way in which the indication information indicates the TCI state according to the value of the first information field in the indication information, and then parses the indication information based on the indication way to obtain the identifier of the TCI state indicated in the indication information. Thus, it is ensured that in the M-TRP transmission system of single DCI, the indication mapping of multiple TRPs is realized, thereby providing conditions for the terminal device to access more TRPs at the same time.

The following is a detailed description of the method for determining the transmission configuration indication TCI state provided by the embodiment of the present disclosure in combination with the flowcharts.

Please refer to FIG. 2, which is a flowchart of a method for determining a transmission configuration indication TCI state provided by the embodiment of the present disclosure. The method provided in this embodiment can be executed by a terminal device. As shown in FIG. 2, the method may include but is not limited to the following steps:
Step 201, determining a value of a first information field in indication information sent by a network device, where the indication information is configured to indicate a TCI state.

The first information field may be a bit in the indication information, or may be several bits in the indication information, which is not limited by the present disclosure.

In some examples, the indication information may be a MAC CE. Correspondingly, the first information field may be one or more bits in the MAC CE.

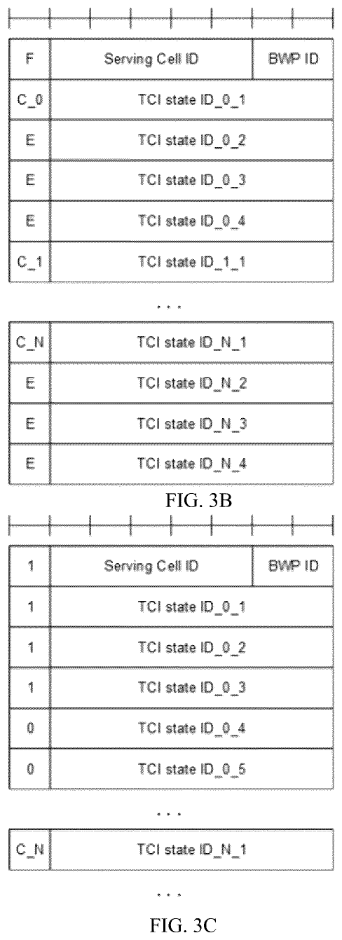

In some examples, the first information field may be one or more reserved bits in the MAC. For example, the first information field may be a reserved bit located before the serving cell ID and the bandwidth part identification (BWP ID), such as the bit where the “F” character is located as shown in FIG. 3A). FIG. 3A to FIG. 3C are structural schematic diagrams of the indication information provided by the present disclosure.
Step 202, determining a way in which the indication information indicates the TCI state according to the value of the first information field.

The indication information in the present disclosure may have a variety of different ways for indicating the TCI state. Moreover, the value of the first information field may be configured to indicate which way is used when the current indication information indicates the TCI state.

In some examples, the network device may determine that the way in which the indication information indicates the TCI state is a first way when the value of the first information field is a first value; or determine that the way in which the indication information indicates the TCI state is a second way when the value of the first information field is a second value, where the first way is different from the second way.

For example, if the first information field is a bit in the MAC CE, then the first value may be 0 and the second value may be 1; or the first value may be 1 and the second value may be 0, and so on, and the present disclosure does not limit this.

Hereinafter, for example, the first value is 0 and the second value is 1. The implementable forms of the indication information in the first way and the second way are explained.

In some examples, when the indication information indicates the TCI state in the first way, the value of the first indication bit in the i-th second information field is configured to indicate whether the i-th TCI state group contains two TCI states. When the value of the first indication bit is a fifth value, it indicates that the i-th state group contains only one TCI state. When the value of the first indication bit is a sixth value, it indicates that the i-th state group contains two TCI states. The identifier of the first TCI state of the i-th TCI state group is indicated by a third information field associated with the first indication bit, where i is a natural number less than or equal to N, N is the maximum number of TCI state groups that the indication information can indicate, and the third information field is an information field configured to indicate the TCI state identifier in the indication information.

The fifth value can be 0, and the sixth value can be 1. Or, the fifth value can be 1, and the sixth value can be 0, etc., and the present disclosure does not limit this.

Hereinafter, for example, the fifth value is 0 and the sixth value is 1, the form of the indication information of the first indication way is explained. The first way in which the indication information indicates the TCI state can be shown in FIG. 3A). As shown in FIG. 3A), in the indication information, the value of the bit where the character “F” is located is 0 (not shown in the figure), and the character “C_i” is configured to indicate whether a second TCI state in the i-th TCI state group exists (that is, whether a first TCI state in the i-th TCI state group is the last TCI state in the state group). If it is 0, it means that the second TCI state does not exist, and if it is 1, it means that the second TCI state exists. R is a reserved bit, which can be set to 0, and TCI state ID_i_j is configured to identify the identifier of the j-th TCI state in the i-th TCI state group. As shown in FIG. 3A), the first way can be configured to indicate the situation where a TCI state group contains at most two TCI states. Among them, i is a natural number less than or equal to the maximum number N of TCI state groups that can be indicated by the indication information, and j is a positive integer less than 2.

In addition, the second way for the indication information to indicate the TCI state can be shown in FIG. 3B). As shown in FIG. 3B), in the indication information, the value of the bit where the character “F” is located is 1 (not shown in the figure). The character “C_i” is configured to indicate whether a second TCI state in the i-th TCI state group exists (that is, whether a first TCI state in the i-th TCI state group is the last TCI state in the state group). The character “E” can be configured to indicate whether the associated TCI state is the last TCI state in the current TCI state group. TCI state ID_i_j is configured to identify an identifier of the j-th TCI state in the i-th TCI state group. As shown in FIG. 3B), the second way can be configured to indicate the situation where the TCI state group contains more TCI states, such as 3 TCI states, 4 TCI states, or 6 TCI states, etc. Among them, i is a natural number less than or equal to the maximum number N of TCI state groups that can be indicated by the indication information, and j is a positive integer.

It should be noted that in the second way, the value of j is related to the maximum number of TCI states contained in each TCI state group. For example, if each TCI state group contains 4 TCI states, then j is a positive integer less than or equal to 4. If each TCI state group contains 6 TCI states, then j is a positive integer less than or equal to 6, etc., and the present disclosure does not limit this.

In addition, the maximum number N of TCI state groups indicated in the MAC CE is related to the number of bits occupied by the TCI information field in the DCI. For example, if the TCI information field in the DCI occupies 3 bits, then the MAC CE can indicate up to 23 TCI state groups, that is, the MAC CE will indicate up to 8 TCI state groups. Or, if the TCI information field in the DCI occupies 4 bits, then the MAC CE can indicate up to 24 TCI state groups, that is, the MAC CE will indicate up to 16 TCI state groups, etc., and the present disclosure does not limit this. One TCI state group can include 2 or more TCI states.

It should be noted that the number of indication bits indicated by the character “E” contained in each second information field group in FIG. 3B) is only for schematic illustration. In actual use, the form of the indication information can be adjusted according to the number of TCI states actually contained in each TCI state group. For example, if the number of TCI states contained in each TCI state group is at most 6, the second information field associated with each TCI state group in the indication information may include 5 indication bits indicated by the character “E”.
Step 203, determining an identifier of the TCI state indicated by the indication information according to the way in which the indication information indicates the TCI state.

In the present disclosure, when the terminal device determines the way in which the indication information indicates the TCI state, it can parse the indication information based on the determined way, such as the first way, according to the meaning of each information field in the first way, to determine the identifier of the TCI state indicated by the indication information. If the terminal device determines that the way in which the indication information indicates the TCI state is the second way, then the terminal device parses the indication information according to the meaning of each information field in the second way to determine the identifier of the TCI state indicated by the indication information, until the identifiers of all TCI states indicated in the indication information are determined.

In the present disclosure, the terminal device first determines the value of the first information field in the received indication information, and then determines the way in which the indication information indicates the TCI state according to the value of the first information field, and then determines the identifier of the TCI state indicated in the indication information according to the determined way. Thus, the terminal device can determine the TCI state groups containing different numbers of TCI states through the indication information of different indication ways, thereby providing conditions for the terminal device to access more TRPs at the same time, and meeting the requirements of joint transmission in a multi-TRP system.

Please refer to FIG. 4, which is a flow chart of another method for determining the transmission configuration indication TCI state provided by an embodiment of the present disclosure. The method provided in this embodiment can be executed by a terminal device. As shown in FIG. 4, the method may include but is not limited to the following steps:
Step 401, determining a value of a first information field in indication information sent by a network device, where the indication information is configured to indicate a TCI state.
Step 402, determining a way in which the indication information indicates the TCI state according to the value of the first information field.

The specific implementation forms of the above steps 401 and 402 can refer to the detailed description of any embodiment of the present disclosure, and will not be repeated here.
Step 403, in a case where the way in which the indication information indicates the TCI state is a second way, determining a value of each indicator bit in a second information field associated with each TCI state group in the indication information.

As shown in FIG. 3A) and FIG. 3B), the respective indicator bits in the second information field are the bits where the characters “C_i”, “R” and “E” in the indication information are located.

In some examples, if the way in which the indication information indicates the TCI state is the second way, the value of the j-th indication bit in the i-th second information field in the indication information is configured to indicate whether the identifier of the j-th TCI state is the last TCI state in the i-th TCI state group, where the identifier of the j-th TCI state in the i-th TCI state group is indicated by a third information field associated with the j-th indication bit, j is a positive integer less than or equal to M, i is a natural number less than or equal to N, M is the maximum number of TCI states contained in each TCI state group, and N is the maximum number of TCI state groups that can be indicated by the indication information. Thus, the terminal device can parse the indication information according to the value of each indication bit in the second information field corresponding to each TCI state group.

For example, when the value of the j-th indication bit is a third value, it indicates that the j-th TCI state is the last TCI state in the i-th TCI state group. When the value of the j-th indication bit is a fourth value, it indicates that the j-th TCI state is not the last TCI state in the i-th TCI state group. The third value can be 0, and the fourth value can be 1. Or, the third value can be 1, and the fourth value can be 0, etc., which is not limited in the present disclosure.

For example, the third value is 1, and the fourth value is 0. If the terminal device determines that the value of the third indicator bit in the second information field associated with the second TCI state group is 1 when parsing the indication information, the terminal device can determine that the third TCI state is not the last one in the second TCI state group, so the value of the fourth indicator bit can be determined. If the value of the fourth indicator bit is 0, it can be determined that the fourth TCI state is the last TCI state in the second TCI state group. After that, a second information field and a third information field associated with the third TCI state group can be further parsed.

The third information field is an information field configured to indicate the TCI state identifier in the indication information, such as the bit positions of the respective “TCI state ID_i_j” fields shown in FIG. 3A) and FIG. 3B).
Step 404, obtaining an identifier of each TCI state in each TCI state group from the indication information according to the value of each indicator bit in the second information field associated with each TCI state group.

In the present disclosure, considering that each indicator bit in the second information field can be configured to indicate whether the currently associated TCI state is the last one in the TCI state group to which it belongs, when determining the identifier of each TCI state, the terminal device can first determine the value of the indicator bit in the second information field, and then determine whether all TCI states in the current TCI state group have been obtained according to the currently determined value of the indicator bit. In other words, according to the value of each indicator bit in the second information field, the terminal device determines whether it is necessary to continue to parse the next indicator bit in the second information field associated with the current TCI state group and the next third information field associated with the current TCI state group.

For example, the terminal device first determines the value of the first indicator bit in the first one of the second information fields (such as the indicator bit where the character “C_0” is located in FIG. 3B). If the value indicates that the first TCI state is not the last TCI state in the first TCI state group, that is, there is a second TCI state in the first TCI state group, then the terminal device can determine the identifier of the first TCI state in the first TCI state group according to the value of the associated third information field (such as the bit corresponding to the “TCI state ID_0_1” field in FIG. 3B).

After that, the terminal device can determine the value of the second indicator bit in the first one of the second information fields (such as the indicator bit where the character “E” adjacent to the character “C_0” is located in FIG. 3B). If the value indicates that the second TCI state is not the last TCI state in the first TCI state group, the terminal device can determine the identifier of the second TCI state in the first TCI state group according to the value of the associated third information field (such as the bit corresponding to the “TCI state ID_0_2” field in FIG. 3C). By analogy, if the value of the fourth indicator bit in the first one of the second information fields indicates that the fourth TCI state is the last TCI state in the first TCI state group, the terminal device can determine the identifier of the fourth TCI state in the first TCI state group according to the value of the associated third information field (such as the bit corresponding to the “TCI state ID_0_4” field in FIG. 3B).

Then the terminal device can determine a value of each indication bit in the second one of the second information fields, such as determining the value of the first indication bit (such as the indication bit where the character “C_1” is located in FIG. 3B), the second indication bit (the character “E” below the character “C_1” in FIG. 3B), etc. in the second one of the second information fields, and then obtain the identifier of each TCI state in the second TCI state group from the associated third information field in the indication information according to the value of each indication bit in the second one of the second information fields.

In the present disclosure, the terminal device first determines the value of the first information field in the received indication information, and then determines that the way in which the indication information indicates the TCI state is the second way according to the value of the first information field, and then determines the value of each indication bit in the second information field associated with each TCI state group in the indication information, and then obtains the identifier of each TCI state in each TCI state group from the indication information according to the value of each indication bit. Thus, the terminal device can determine the TCI state groups containing different numbers of TCI states through the indication information of different indication ways, thereby providing conditions for the terminal device to access more TRPs at the same time, and meeting the requirements of joint transmission in a multi-TRP system.

Please refer to FIG. 5, which is a flow chart of another method for determining the transmission configuration indication TCI state provided by the embodiment of the present disclosure. The method provided in this embodiment can be executed by a network device. As shown in FIG. 4, the method may include but is not limited to the following steps:
Step 501, determining a way for indicating a TCI state to a terminal device.

The network device can indicate the state groups containing different numbers of TCI states to the terminal device in different ways. For example, the state group containing up to 2 TCI states can be indicated to the terminal device through way 1, or the state group containing up to 4 TCI states can be indicated to the terminal device through way 2, etc., and the present disclosure does not limit this.

In the present disclosure, the network device can determine the way for indicating the TCI state to the terminal device according to the type of the terminal device, or the maximum number of TRPs that the terminal device can support to access at the same time.
Step 502, determining a value of a first information field in indication information according to the way for indicating the TCI state, where the indication information is configured to indicate the TCI state.

The first information field can be a bit in the indication information, or it can also be several bits in the indication information, which is not limited in the present disclosure.

In some examples, the indication information is a media access control element MAC CE. Accordingly, the first information field can be one or more bits in the MAC CE.

In some examples, the first information field may be one or more reserved bits in the MAC. For example, the first information field may be a reserved bit located before the serving cell ID and the bandwidth part identification (BWP ID), such as the bit where the “F” character is located as shown in FIG. 3A).

In some examples, the network device may determine that the value of the first information field is a first value when determining the way for indicating the TCI state to be a first way. Or, the network device determines that the value of the first information field is a second value when determining the way for indicating the TCI state to be a second way, where the first way is different from the second way.

For example, if the first information field is a bit in the MAC CE, the first value may be 0 and the second value may be 1, or the first value may be 1 and the second value may be 0, and the like, and the present disclosure does not limit this.

Hereinafter, for example, the first value as 0 and the second value as 1. The implementable forms of the indication information in the first way and the second way are explained.

In some examples, when the indication information indicates the TCI state in the first way, the value of the first indication bit in the i-th second information field is configured to indicate whether the i-th TCI state group contains two TCI states. When the value of the first indication bit is a fifth value, it indicates that the i-th state group contains only one TCI state. When the value of the first indication bit is a sixth value, it indicates that the i-th state group contains two TCI states. The identifier of the first TCI state of the i-th TCI state group is indicated by a third information field associated with the first indication bit, where i is a natural number less than or equal to N, N is the maximum number of TCI state groups that the indication information can indicate, and the third information field is an information field configured to indicate the TCI state identifier in the indication information.

The fifth value can be 0, and the sixth value can be 1. Or, the fifth value can be 1, and the sixth value can be 0, etc., and the present disclosure does not limit this.

Hereinafter, for example, the fifth value is 0 and the sixth value is 1, the form of the indication information of the first indication way is explained. The first way in which the indication information indicates the TCI state can be shown in FIG. 3A). As shown in FIG. 3A), in the indication information, the value of the bit where the character “F” is located is 0 (not shown in the figure), and the character “C_i” is configured to indicate whether a second TCI state in the i-th TCI state group exists (that is, whether a first TCI state in the i-th TCI state group is the last TCI state in the state group). If it is 0, it means that the second TCI state does not exist, and if it is 1, it means that the second TCI state exists. R is a reserved bit, which can be set to 0, and TCI state ID_i_j is configured to identify the identifier of the j-th TCI state in the i-th TCI state group. As shown in FIG. 3A), the first way can be configured to indicate the situation where a TCI state group contains at most two TCI states. Among them, i is a natural number less than or equal to the maximum number N of TCI state groups that can be indicated by the indication information, and j is a positive integer less than 2.

In addition, the second way for the indication information to indicate the TCI state can be shown in FIG. 3B). As shown in FIG. 3B), in the indication information, the value of the bit where the character “F” is located is 1 (not shown in the figure). The character “C_i” is configured to indicate whether a second TCI state in the i-th TCI state group exists (that is, whether a first TCI state in the i-th TCI state group is the last TCI state in the state group). the character “E” can be configured to indicate whether the associated TCI state is the last TCI state in the current TCI state group. TCI state ID_i_j is configured to identify an identifier of the j-th TCI state in the i-th TCI state group. As shown in FIG. 3B), the second way can be configured to indicate the situation where the TCI state group contains more TCI states, such as 3 TCI states, 4 TCI states, or 6 TCI states, etc. Among them, i is a natural number less than or equal to the maximum number N of TCI state groups that can be indicated by the indication information, and j is a positive integer.

It should be noted that in the second way, the value of j is related to the maximum number of TCI states contained in each TCI state group. For example, if each TCI state group contains 4 TCI states, then j is a positive integer less than or equal to 4. If each TCI state group contains 6 TCI states, then j is a positive integer less than or equal to 6, etc., and the present disclosure does not limit this.

In addition, the maximum number N of TCI state groups indicated in the MAC CE is related to the number of bits occupied by the TCI information field in the DCI. For example, if the TCI information field in the DCI occupies 3 bits, then the MAC CE can indicate up to 23 TCI state groups, that is, the MAC CE will indicate up to 8 TCI state groups. Or, if the TCI information field in the DCI occupies 4 bits, then the MAC CE can indicate up to 24 TCI state groups, that is, the MAC CE will indicate up to 16 TCI state groups, etc., and the present disclosure does not limit this. One TCI state group can include 2 or more TCI states.

It should be noted that the number of indication bits indicated by the character “E” contained in each second information field group in FIG. 3B) is only for schematic illustration. In actual use, the form of the indication information can be adjusted according to the number of TCI states actually contained in each TCI state group. For example, if the number of TCI states contained in each TCI state group is at most 6, the second information field associated with each TCI state group in the indication information may include 5 indication bits indicated by the character “E”.
Step 503, sending the indication information to the terminal device.

It should be noted that, since the meaning of each information field may be different when the network device indicates the TCI state to the terminal device in different ways, the network device in the present disclosure indicates the form of the indication information to the terminal device through the value of the first information field in the indication information in order to ensure that the terminal device can accurately parse the indication information. After the indication information is generated, the generated indication information is sent to the terminal device.

In the present disclosure, the network device first determines the way for indicating the TCI state to the terminal device, and then determines the value of the first information field in the indication information according to the way to indicate the TCI state to the terminal device, and then sends the indication information to the terminal device. Thus, the network device indicates the TCI state groups containing different numbers of TCI states to the terminal device through the indication information in different ways, thereby providing conditions for the terminal device to access more TRPs at the same time, and meeting the requirements of joint transmission in a multi-TRP system.

Please refer to FIG. 6, which is a flow chart of another method for determining the transmission configuration indication TCI state provided by an embodiment of the present disclosure. The method is executed by a network device. As shown in FIG. 6, the method may include but is not limited to the following steps:
Step 61, determining a way for indicating a TCI state to a terminal device.
Step 62, determining a value of a first information field in indication information according to the way for indicating the TCI state, where the indication information is configured to indicate the TCI state.

The specific implementations of the above steps 61 and 62 can refer to the detailed description of any embodiment of the present disclosure, and will not be repeated here.
Step 63, in a case where the way for indicating the TCI state is a second way, determining a value of each indicator bit in a second information field associated with each TCI state group in the indication information according to a number of TCI states contained in each TCI state group.

As shown in FIG. 3A) and FIG. 3B), the respective indicator bits in the second information field are the bits where the characters “C_i”, “R” and “E” in the indication information are located.

In some examples, the way for indicating the TCI state in the indication information is a second way, and the value of the j-th indicator bit in the i-th second information field is configured to indicate whether the identifier of the j-th TCI state is the last TCI state in the i-th TCI state group, where the identifier of the j-th TCI state in the i-th TCI state group is indicated by a third information field associated with the j-th indicator bit, j is a positive integer less than or equal to M, i is a natural number less than or equal to N, M is the maximum number of TCI states contained in each TCI state group, and N is the maximum number of TCI state groups that can be indicated by the indication information.

For example, when the value of the j-th indicator bit is a third value, it indicates that the j-th TCI state is the last TCI state in the i-th TCI state group. When the value of the j-th indicator bit is a fourth value, it indicates that the j-th TCI state is not the last TCI state in the i-th TCI state group.

The third value can be 0, and the fourth value can be 1. Or, the third value can be 1, and the fourth value can be 0, etc., which is not limited in the present disclosure.

The third information field is an information field configured to indicate the TCI state identifier in the indication information, such as the bit positions of the respective “TCI state ID_i_j” fields shown in FIG. 3A) and FIG. 3B).

In some examples, when the way in which the indication information indicates the TCI state in a second way, the network device determines that the values of the first K−1 indication bits in the m-th second information field in the indication information are the third values, and the values of the K-th to (L−1)-th second indication bits are the fourth value in a case where the network device determines that the number of TCI states included in the m-th TCI state group is K. L is the number of indication bits included in each second information field, and m is a natural number less than or equal to N.

The third value may be 0, and the fourth value may be 1. Or, the third value may be 1, and the fourth value may be 0, etc., which is not limited in the present disclosure.

For example, the third value is 0, the fourth value is 1, and the second indication field associated with each TCI state group in the indication information includes 5 indication bits. Then, when the network device determines that the number of TCI states included in the first TCI state group is 4, the network device can determine that the values of the first three indication bits in the first one of the second information fields in the indication information are all the third values, and the value of the fourth indication bit is the fourth value. That is, the indication information can be as shown in FIG. 3C.

In addition, the network device can determine the value of the bit corresponding to the “TCI state ID_i_j” field shown in FIG. 3C according to the identifier of each TCI state contained in each TCI state group.
Step 64, sending the indication information to the terminal device.

The specific implementation of the above step 64 can refer to the detailed description of any embodiment of the present disclosure, and will not be repeated here.

In the present disclosure, the network device first determines the value of the first information field in the indication information according to the way for indicating the TCI state to the terminal device, and then when the network device determines that the way for indicating the TCI state to the terminal device is a second way, the network device determines the value of each indication bit in the associated second information field in the indication information according to the number of TCI states contained in the TCI state group to be indicated to the terminal device, and then sends the indication information to the terminal device. Thus, the network device indicates the TCI state groups containing different numbers of TCI states to the terminal device through indication information in different ways, thereby providing conditions for the terminal device to access more TRPs at the same time, and meeting the requirements of joint transmission in a multi-TRP system.

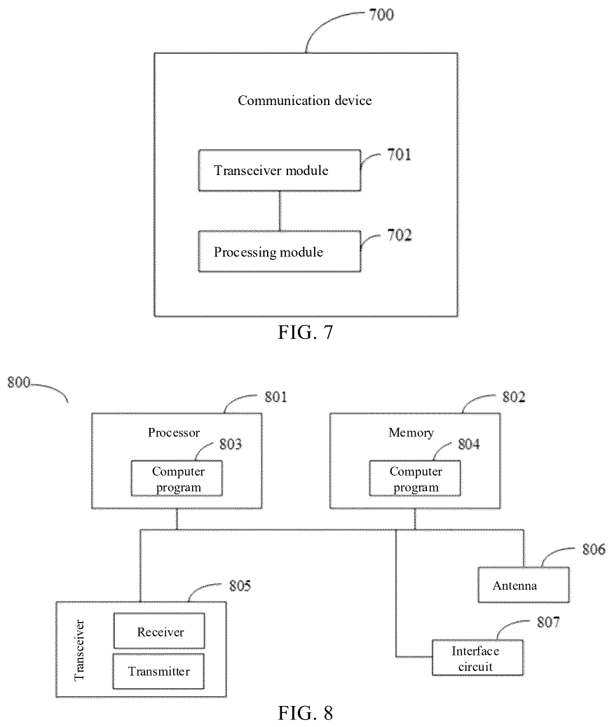

Please refer to FIG. 7, which is a schematic diagram of a structure of a communication device provided by an embodiment of the present disclosure. The communication device 700 shown in FIG. 7 may include a transceiver module 701 and a processing module 702. The transceiver module 701 may include a sending module and/or a receiving module. The sending module is configured to implement the sending function, the receiving module is configured to implement the receiving function, and the transceiver module 701 can implement the sending function and/or the receiving function.

It can be understood that the communication device 700 can be a terminal device, or it can also be a device in a terminal device, or it can also be a device that can be used with a terminal device. Alternatively, the communication device 700 can be a network device, or it can also be a device in a network device, or it can also be a device that can be used with a network device.

In some examples, the communication device 700 is on the terminal device side, where:
the processing module 702 is configured to determine a value of a first information field in indication information sent by the network device, where the indication information is configured to indicate a TCI state;
the processing module 702 is further configured to determine a way in which the indication information indicates the TCI state according to the value of the first information field;
the processing module 702 is further configured to determine an identifier of the TCI state indicated by the indication information according to a way in which the indication information indicates the TCI state.

In some examples, the processing module 702 is further configured to perform at least one of the following:
in a case where the value of the first information field is a first value, determining that the way in which the indication information indicates the TCI state is a first way;
in a case where the value of the first information field is a second value, determining that the way in which the indication information indicates the TCI state is a second way, wherein the first way is different from the second way.

In some examples, the processing module 702 is further configured to:
in a case where the way in which the indication information indicates the TCI state is a second way, determine a value of each indication bit in a second information field associated with each TCI state group in the indication information;
according to the value of each indication bit in the second information field associated with each TCI state group, obtain an identifier of each TCI state in each TCI state group from the indication information.

In some examples, the value of the j-th indicator bit in the i-th second information field is configured to indicate whether the identifier of the j-th TCI state is the last TCI state in the i-th TCI state group.

When the value of the j-th indicator bit is the third value, it indicates that the j-th TCI state is the last TCI state in the i-th TCI state group. When the value of the j-th indicator bit is the fourth value, it indicates that the j-th TCI state is not the last TCI state in the i-th TCI state group.

The identifier of the j-th TCI state of the i-th TCI state group is indicated by the third information field associated with the j-th indicator bit, j is a positive integer less than or equal to M, i is a natural number less than or equal to N, M is the maximum number of TCI states contained in each of the TCI state groups, and N is the maximum number of TCI state groups that can be indicated by the indication information, where the third information field is an information field configured to indicate the TCI state identifier in the indication information.

In some examples, N is associated with the number of bits occupied by the TCI information field in the downlink control information DCI.

In some examples, in a case where the way in which the indication information indicates the TCI state is the first manner, the value of the first indication bit in the i-th second information field is configured to indicate whether the second TCI state exists in the i-th TCI state group, and where,
when the value of the first indication bit is the fifth value, it indicates that the second TCI state does not exist in the i-th state group;
when the value of the first indication bit is the sixth value, it indicates that the second TCI state exists in the i-th state group;
where the identifier of the first TCI state of the i-th TCI state group is indicated by the third information field associated with the first indication bit, i is a natural number less than or equal to N, N is the maximum number of TCI state groups that the indication information can indicate, and the third information field is an information field configured to indicate the TCI state identifier in the indication information.

In some examples, the indication information is a media access control element MAC CE.

In the present disclosure, the terminal device first determines the value of the first information field in the received indication information, and then determines the way in which the indication information indicates the TCI state according to the value of the first information field, and then determines the identifier of the TCI state indicated in the indication information according to the determined way. Thus, the terminal device can determine the TCI state groups containing different numbers of TCI states through the indication information in different indication ways, thereby providing conditions for the terminal device to access more TRPs at the same time, and meeting the requirements of joint transmission in a multi-TRP system.

Or, the communication device 700 is on the network device side, where:
the processing module 702 is configured to determine a way for indicating a TCI state to a terminal device;
the processing module 702 is further configured to determine a value of a first information field in indication information according to the way for indicating the TCI state, where the indication information is configured to indicate the TCI state;
the transceiver module 701 is configured to send the indication information to the terminal device.

In some examples, the processing module 702 is further configured to perform at least one of the following:
in a case where the way for indicating the TCI state is a first way, determining the value of the first information field to be a first value;
in a case where the way for indicating the TCI state is a second method, determining the value of the first information field to be a second value, where the first way is different from the second way.

In some examples, the processing module 702 is further configured to determine a value of each indication bit in the second information field associated with each TCI state group in the indication information according to the number of TCI states contained in each TCI state group in a case where the way for indicating the TCI state is the second way.

In some examples, the value of the j-th indicator bit in the i-th second information field is configured to indicate whether the identifier of the j-th TCI state is the last TCI state in the i-th TCI state group.

When the value of the j-th indicator bit is the third value, it indicates that the j-th TCI state is the last TCI state in the i-th TCI state group. When the value of the j-th indicator bit is the fourth value, it indicates that the j-th TCI state is not the last TCI state in the i-th TCI state group.

The identifier of the j-th TCI state in the i-th TCI state group is indicated by the third information field associated with the j-th indicator bit, j is a positive integer less than or equal to M, i is a natural number less than or equal to N, M is the maximum number of TCI states contained in each TCI state group, N is the maximum number of TCI state groups that can be indicated by the indication information, and the third information field is an information field configured to indicate the TCI state identifier in the indication information.

In some examples, N is associated with the number of bits occupied by the TCI information field in the downlink control information DCI.

In some examples, the processing module 701 is further configured to determine the values of the first K−1 indicator bits in the m-th second information field in the indication information are the third values, and the values of the K-th to (L−1)-th second indicator bits are the fourth value in a case where the number of TCI states included in the m-th TCI state group is K, where Lis the number of indicator bits included in each second information field, and m is a natural number less than or equal to N.

In some examples, in a case where the way in which the indication information indicates the TCI state is the first way, the value of the first indication bit in the i-th second information field is configured to indicate whether the second TCI state exists in the i-th TCI state group, and where,
when the value of the first indication bit is the fifth value, it indicates that the second TCI state does not exist in the i-th state group;
when the value of the first indication bit is the sixth value, it indicates that the second TCI state exists in the i-th state group;
where the identifier of the first TCI state of the i-th TCI state group is indicated by the third information field associated with the first indication bit, i is a natural number less than or equal to N, N is the maximum number of TCI state groups that can be indicated by the indication information, and the third information field is an information field configured to indicate the TCI state identifier in the indication information.

In some examples, the indication information is a media access control element MAC CE.

In the present disclosure, the network device first determines the way for indicating the TCI state to the terminal device, and then determines the value of the first information field in the indication information according to the way for indicating the TCI state to the terminal device, and then sends the indication information to the terminal device. Thus, the network device indicates to the terminal device TCI state groups containing different numbers of TCI states through indication information in different ways, thereby providing conditions for the terminal device to access more TRPs at the same time and meeting the requirements of joint transmission in a multi-TRP system.

Please refer to FIG. 8, which is a structural schematic diagram of another communication device provided in an embodiment of the present disclosure. The communication device 800 can be a terminal device, or a chip, a chip system, or a processor that supports the terminal device to implement the above method. Alternatively, the communication device 800 can be a network device, or a chip, a chip system, or a processor that supports the network device to implement the above method. The device can be configured to implement the method described in the above method embodiment, and the details can be referred to the description in the above method embodiment.

The communication device 800 can include one or more processors 801. The processor 801 can be a general-purpose processor or a dedicated processor. For example, it can be a baseband processor or a central processing unit. The baseband processor can be configured to process the communication protocol and communication data, and the central processing unit can be configured to control the communication device (such as a base station, a baseband chip, a terminal device, a terminal device chip, a DU or a CU, etc.), execute a computer program, and process data of the computer program.

In some examples, the communication device 800 may further include one or more memories 802, on which a computer program 804 may be stored. The processor 801 executes the computer program 804 so that the communication device 800 performs the method described in the above method embodiment. In some examples, data may also be stored in the memory 802. The communication device 800 and the memory 802 may be provided separately or integrated together.

In some examples, the communication device 800 may further include a transceiver 805 and an antenna 806. The transceiver 805 may be referred to as a transceiver unit, a transceiver, or a transceiver circuit, etc., for implementing receiving and transmitting functions. The transceiver 805 may include a receiver and a transmitter. The receiver may be referred to as a receiver machine or a receiving circuit, etc., for implementing a receiving function. The transmitter may be referred to as a transmitter machine or a transmitting circuit, etc., for implementing a transmitting function.

In some examples, the communication device 800 may further include one or more interface circuits 807. The interface circuit 807 is configured to receive code instructions and transmit them to the processor 801. The processor 801 runs the code instructions to enable the communication device 800 to perform the method described in the above method embodiment.

The transceiver 805 in the communication device 800 can be configured to perform the receiving and transmitting steps in the above-mentioned figures, and the processor 801 can be configured to perform the processing steps in the above-mentioned figures.

In one implementation, the processor 801 may include a transceiver for implementing the receiving and transmitting functions. For example, the transceiver may be a transceiver circuit, or an interface, or an interface circuit. The transceiver circuit, interface or interface circuit for implementing the receiving and transmitting functions may be separate or integrated. The above-mentioned transceiver circuit, interface or interface circuit may be used for reading and writing code/data, or the above-mentioned transceiver circuit, interface or interface circuit may be used for signal transmission or delivery.

In one implementation, the processor 801 may store a computer program 803, and the computer program 803 runs on the processor 801, so that the communication device 800 can perform the method described in the above-mentioned method embodiment. The computer program 803 may be embedded in the processor 801, in which case the processor 801 may be implemented by hardware.

In one implementation, the communication device 800 may include a circuit, and the circuit may implement the functions of sending or receiving or communicating in the above-mentioned method embodiment. The processor and transceiver described in the present disclosure can be implemented in an integrated circuit (IC), an analog IC, a radio frequency integrated circuit RFIC, a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or an intelligent relay, but the scope of the communication device described in the present disclosure is not limited thereto, and the structure of the communication device may not be limited to FIG. 8. The communication device may be an independent device or may be part of a larger device. For example, the communication device may be:
(1) an independent integrated circuit IC, or a chip, or a chip system or subsystem;
(2) a collection of one or more ICs, in some examples, the IC collection may further include a storage component for storing data or computer programs;
(3) an ASIC, such as a modem;
(4) a module that can be embedded in other devices;
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

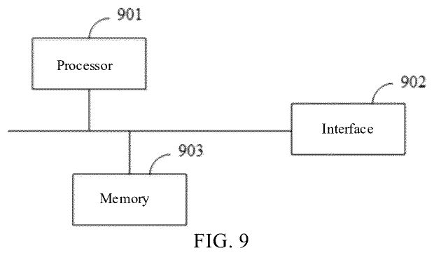

For the case where the communication device may be a chip or a chip system, the schematic diagram of the chip structure shown in FIG. 9 can be referred to. The chip shown in FIG. 9 includes a processor 901 and an interface 902. The number of processors 901 may be one or more, and the number of interfaces 902 may be multiple.

For the case where the chip is configured to implement the functions of the terminal device in the embodiment of the present disclosure.

In some examples, the chip further includes a memory 903, which is configured to store necessary computer programs and data.

Those skilled in the art may also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions described for each specific application, but such implementation should not be understood as exceeding the scope of protection of the embodiments of the present disclosure.

The present disclosure also provides a readable storage medium on which instructions are stored, and when the instructions are executed by a computer, the functions of any of the above method embodiments are implemented.

The present disclosure also provides a computer program product, which, when executed by a computer, implements the functions of any of the above method embodiments.

In the above embodiments, it can be implemented in whole or in part by software, hardware, firmware, or any combination thereof. When implemented by software, it can be implemented in whole or in part in the form of a computer program product. The computer program product includes one or more computer programs. When the computer program is loaded and executed on a computer, the process or function described in the embodiments of the present disclosure is generated in whole or in part. The computer may be a general-purpose computer, a special-purpose computer, a computer network, or other programmable device. The computer program may be stored in a computer-readable storage medium, or transmitted from one computer-readable storage medium to another computer-readable storage medium. For example, the computer program may be transmitted from one website, computer, server or data center to another website, computer, server or data center by wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or data center that includes one or more available media integrated therein. The available medium may be a magnetic medium (e.g., a floppy disk, a hard disk, a tape), an optical medium (e.g., a high-density digital video disc (DVD)), or a semiconductor medium (e.g., a solid state disk (SSD)), etc.

Those skilled in the art may understand that the various digital numbers such as the first and second involved in the present disclosure are only used for the convenience of description, and are not used to limit the scope of the embodiments of the present disclosure, and also indicate the order of precedence.

The expression of “at least one” in the present disclosure may also be described as one or more, and multiple may be two, three, four or more, which is not limited by the present disclosure. In the embodiments of the present disclosure, for a kind of technical feature, the technical features in the kind of technical feature are distinguished by “first”, “second”, “third”, “A”, “B”, “C” and “D”, etc., and there is no order of precedence or size among the technical features described by the “first”, “second”, “third”, “A”, “B”, “C” and “D”.

The correspondences shown in the tables in the present disclosure can be covered ranges or predefined. The values of the information in each table are only examples, and the coverage range can be other values, which are not limited by the present disclosure. When the coverage range information corresponds to each parameter, it is not necessarily required to cover all the correspondences illustrated in the tables. For example, in the table in the present disclosure, the correspondences shown in some rows may not cover the range. For another example, appropriate deformation adjustments can be made based on the above table, such as splitting, merging, etc. The names of the parameters shown in the titles of the above tables can also use other names that can be understood by the communication device, and the values or representations of the parameters can also be other values or representations that can be understood by the communication device. When implementing the above tables, other data structures may also be used, such as arrays, queues, containers, stacks, linear lists, pointers, linked lists, trees, graphs, structures, classes, heaps, hash tables or hash tables.

The pre-definition in the present disclosure may be understood as definition, pre-definition, storage, pre-storage, pre-negotiation, pre-coverage, solidification, or pre-burning.

Those skilled in the art may realize that the units and algorithm steps of the examples described in the embodiments disclosed herein may be implemented in electronic hardware or in a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present disclosure.

Those skilled in the art may clearly understand that for the convenience and simplicity of description, the specific working process of the above-described system, device and unit may refer to the corresponding process in the aforementioned method embodiment, and will not be repeated here.

The above is only a specific embodiment of the present disclosure, but the protection scope of the present disclosure is not limited thereto. Those skilled in the art who is familiar with the technical field can easily think of changes or substitutions within the technical scope disclosed in the present disclosure, which should be included in the protection scope of the present disclosure. Therefore, the protection scope of the present disclosure should be based on the protection scope of the claims.

1. A method for determining a transmission configuration indication (TCI) state, performed by a terminal device, comprising:
determining a value of a first information field in indication information sent by a network device, wherein the indication information is configured to indicate a TCI state;
determining a way in which the indication information indicates the TCI state according to the value of the first information field; and
determining an identifier of the TCI state indicated by the indication information according to the way in which the indication information indicates the TCI state.

2. The method according to claim 1, wherein determining the way in which the indication information indicates the TCI state according to the value of the first information field comprises at least one of:
in a case where the value of the first information field is a first value, determining the way in which the indication information indicates the TCI state is a first way; and
in a case where the value of the first information field is a second value, determining the way in which the indication information indicates the TCI state is a second way, wherein the second way is different from the first way.

3. The method according to claim 2, wherein determining the identifier of the TCI state indicated by the indication information according to the way in which the indication information indicates the TCI state comprises:
in a case where the way in which the indication information indicates the TCI state is the second way, determining a value of each indicator bit in a second information field associated with each TCI state group in the indication information; and
obtaining an identifier of each TCI state in each TCI state group from the indication information according to the value of each indicator bit in the second information field associated with each TCI state group.

4. The method according to claim 3, wherein a value of a j-th indicator bit in an i-th second information field is configured to indicate whether an identifier of a j-th TCI state is the last TCI state in an i-th TCI state group, and wherein,
in response to determining that the value of the j-th indicator bit is a third value, the j-th TCI state is the last TCI state in the i-th TCI state group;
in response to determining that the value of the j-th indicator bit is a fourth value, the j-th TCI state is not the last TCI state in the i-th TCI state group;
wherein the identifier of the j-th TCI state of the i-th TCI state group is indicated by a third information field associated with the j-th indicator bit, j is a positive integer less than or equal to M, i is a natural number less than or equal to N, M is a maximum number of TCI states contained in each TCI state group, N is a maximum number of TCI state groups that the indication information is able to indicate, and the third information field is an information field configured to indicate the TCI state identifier in the indication information.

5. The method according to claim 4, wherein the N is associated with a number of bits occupied by a TCI information field in downlink control information (DCI).

6. The method according to claim 1, wherein
in a case where the indication information indicates the TCI state in a first way, a value of a first indication bit in an i-th second information field is configured to indicate whether a second TCI state exists in an i-th TCI state group, and wherein,
in a case where the value of the first indication bit is a fifth value, the second TCI state does not exist in the i-th TCI state group;
in a case where the value of the first indication bit is a sixth value, the second TCI state exists in the i-th TCI state group;
wherein an identifier of a first TCI state of the i-th TCI state group is indicated by a third information field associated with the first indication bit, i is a natural number less than or equal to N, N is a maximum number of TCI state groups that the indication information is able to indicate, and the third information field is an information field configured to indicate the TCI state identifier in the indication information.

7. The method according to claim 1, wherein the indication information is a media access control element (MAC CE).

8. A method for determining a transmission configuration indication (TCI) state, performed by a network device, comprising:
determining a way for indicating a TCI state to a terminal device;
determining a value of a first information field in indication information according to the way for indicating the TCI state, wherein the indication information is configured to indicate the TCI state; and
sending the indication information to the terminal device.

9. The method according to claim 8, wherein determining the value of the first information field in indication information according to the way for indicating the TCI state comprises at least one of:
in a case where the way for indicating the TCI state is a first way, determining the value of the first information field as a first value;
in a case where the way for indicating the TCI state is a second way, determining the value of the first information field as a second value, wherein the second way is different from the first way.

10. The method according to claim 8, further comprising:
in a case where the way for indicating the TCI state is the second way, determining a value of each indicator bit in a second information field associated with each TCI state group in the indication information according to a number of TCI states contained in each TCI state group.

11. The method according to claim 10, wherein a value of a j-th indicator bit in an i-th second information field is configured to indicate whether an identifier of a j-th TCI state is the last TCI state in an i-th TCI state group, and wherein,
in response to determining that the value of the j-th indicator bit is a third value, the j-th TCI state is the last TCI state in the i-th TCI state group;
in response to determining that the value of the j-th indicator bit is a fourth value, the j-th TCI state is not the last TCI state in the i-th TCI state group;
wherein the identifier of the j-th TCI state in the i-th TCI state group is indicated by a third information field associated with the j-th indicator bit, j is a positive integer less than or equal to M, i is a natural number less than or equal to N, M is a maximum number of TCI states contained in each of the TCI state groups, N is a maximum number of TCI state groups that the indication information is able to indicate, wherein the third information field is an information field configured to indicate the TCI state identifier in the indication information.

12. The method according to claim 11, wherein the N is associated with a number of bits occupied by a TCI information field in downlink control information (DCI).

13. The method according to claim 11, wherein determining the value of each indicator bit in the second information field associated with each TCI state group in the indication information according to the number of TCI states contained in each TCI state group comprising:
in a case where a number of TCI states contained in a m-th TCI state group is K, determining values of first K−1 indicator bits in the m-th second information field in the indication information as the third values, and determining values of K-th to (L−1)-th second indicator bits as the fourth values, wherein L is a number of indicator bits contained in each second information field, and m is a natural number less than or equal to N.

14. The method according to claim 8, wherein
in a case where the indication information indicates the TCI state is a first way, a value of a first indication bit in an i-th second information field is configured to indicate whether a second TCI state exists in an i-th TCI state group, and wherein,
in response to determining that the value of the first indication bit is a fifth value, the second TCI state does not exist in the i-th TCI state group;
in response to determining that the value of the first indication bit is a sixth value, the second TCI state exists in the i-th TCI state group;
wherein an identifier of a first TCI state of the i-th TCI state group is indicated by a third information field associated with the first indication bit, i is a natural number less than or equal to N, N is a maximum number of TCI state groups that the indication information is able to indicate, and the third information field is an information field configured to indicate the TCI state identifier in the indication information.

15. The method according to claim 8, wherein the indication information is a media access control element (MAC CE).

16.-18. (canceled)

19. A communication device, comprising a processor and a memory, wherein the memory stores a computer program, and the processor executes the computer program stored in the memory to cause the device to:
determining a value of a first information field in indication information sent by a network device, wherein the indication information is configured to indicate a TCI state;
determining a way in which the indication information indicates the TCI state according to the value of the first information field; and
determining an identifier of the TCI state indicated by the indication information according to the way in which the indication information indicates the TCI state.

20. A non-transitory computer-readable storage medium, for storing instructions, when the instructions are executed, the method according to claim 1 is implemented.

21. A communication device, comprising a processor and a memory, wherein the memory stores a computer program, and the processor executes the computer program stored in the memory to cause the device to execute the method according to claim 8.

22. A non-transitory computer-readable storage medium, for storing instructions, when the instructions are executed, the method according to claim 8 is implemented.
